(19) United States
(12) Patent Application Publication
(10) Pub. No.: US 2013/0019587 A1
(43) Pub. Date: Jan. 24, 2013

(54) THRUSTER DEVICES AND METHODS OF MAKING THRUSTER DEVICES FOR USE WITH THRUST VECTOR CONTROL SYSTEMS

(71) Applicants: Isaac Hoffman, Kaysville, UT (US); Brett Hussey, Bountiful, UT (US); Randy Clark, Kaysville, UT (US); Kenneth J. Clark, Morgan, UT (US)

(72) Inventors: Isaac Hoffman, Kaysville, UT (US); Brett Hussey, Bountiful, UT (US); Randy Clark, Kaysville, UT (US); Kenneth J. Clark, Morgan, UT (US)

(21) Appl. No.: 13/187,752

(22) Filed: Jul. 21, 2011

(51) Int. Cl. F02K 9/32; F02K 9/95

(52) U.S. Cl. 60/256; 29/890.01

(57) ABSTRACT

Thruster devices for use with a lateral thrust module and/or a flight body are adapted to achieve short action times with relatively slow burning propellant materials. Such thruster devices include a combustion chamber with a plurality of propellant grains disposed therein. At least some of the plurality of propellant grains are formed into a selected shape. Methods of making thruster devices include forming a housing comprising a first longitudinal end and an opposing second longitudinal end. The housing is formed to define a combustion chamber. A plurality of propellant grains are disposed in the combustion chamber of the housing, where each propellant grain comprises a selected shape. An igniter is coupled to the housing, which igniter is adapted to initiate a combustion of the plurality of propellant grains during deployment of the thruster device.

### TECHNICAL FIELD

The present disclosure relates generally to thruster devices for controlling the attitude of a flying body. More specifically, various embodiments of the present disclosure relate to vector thrust devices and methods of making vector thrust devices for use in thrust vector control systems of flying bodies.

### BACKGROUND

Various self-propelled flying bodies, such as rockets and missiles, are typically employed for a variety of uses, such as military and scientific. One of the basic goals of the technology of flight bodies is to improve the maneuverability of the body. The maneuverability of a flight body is related to its ability to change its flight path. Since lateral forces may cause a flight body to change its flight path, the maneuverability of a flight body is related to its ability to develop lateral forces. Various approaches are conventionally applied to develop lateral forces for controlling the attitude and direction of the flight body (e.g., controlling the pitch, yaw, and roll of the flight body).

One conventional means for controlling the attitude and direction of flight bodies includes the use of thrust motors positioned to generate a transverse thrust which provide lateral forces on the flight body. A lateral thrust motor is typically employed in combination with one or more other lateral thrust motors to form a lateral thrust module, which may also be characterized as a divert propulsion system. Generally, a lateral thrust motor is mounted on the flight body to generate thrust in a transverse direction during deployment. The thrust is conventionally generated by injecting high pressure gas, or by combusting a propellant, such as a solid propellant.

The solid propellant used in conventional lateral thrust motors is typically formed into a single unit that is referred to as a grain. The conventional single grain of solid propellant is typically formed large enough to at least substantially fill a chamber in the lateral thrust motor, resulting in a substantially thick grain. With conventional lateral thrust motors, it is typically desired to combust all the propellant material of the grain within a specified period of time in order to achieve a desired net force from the thrust motor.

In manufacturing such propellant grains having the required short action time, it becomes a trade-off between two options, faster-burning propellants and slower-burning propellants. When using a relatively faster-burning propellant (e.g., high burn-rate propellant), the creation of the grain becomes easier, as the burn web (minimum distance between two surfaces of the grain) can be large. However, when creating the chemistry for such high burn-rate propellant material, it is more difficult to keep the burn rate consistent from part to part. For example, fast-burning solid propellant materials typically employ very fine powders that are costly to produce, and that can vary substantially in particle size between manufactured lots when mass produced, resulting in inconsistent burn rates, variable thrust values, and less predictability from part to part.

On the other hand, when using a relatively slower-burning propellant (e.g., low burn-rate propellant), it is easier to produce grains having more consistent burn-rates from part to part, but it becomes more difficult to create grain geometry that has a thin enough burn web for the short action time needed.

### BRIEF SUMMARY

In accordance with one or more aspects of the present disclosure, thruster devices and/or lateral thrust modules are provided for use in a flight body, such as a rocket or missile, which thruster devices are adapted to facilitate use of propellant materials having relatively low burning rates, while still achieving relatively short action times. Such thruster devices may reduce the costs and danger involved in manufacturing and handling the propellant materials, and may improve the consistency of thrust values between thruster devices and between manufactured lots of thruster devices, resulting in greater predictability in thrust forces that will result when initiated.

Various embodiments of the present disclosure comprise thruster devices employable in a flight body for generating a transverse thrust. In one or more embodiments, a thruster device may comprise a combustion chamber with a plurality of propellant grains disposed therein. At least some of the plurality of propellant grains are formed into at least one selected shape. An igniter is located in relation to the plurality of propellant grains to initiate combustion of the plurality of propellant grains when the thruster device is deployed.

Other embodiments of the present disclosure include lateral thrust modules employable in a flight body for adjusting attitude and direction of the flight body. In one or more embodiments, a lateral thrust module may comprise a plurality of thruster devices. Each thruster device is oriented to direct a thrust in one of a plurality of different directions. Each thruster device may include a housing defining a combustion chamber and including an injection nozzle at a first longitudinal end thereof. The injection nozzle can be adapted to be joined to an aperture of a flight body. A quantity of propellant material can be disposed within the combustion chamber, where the quantity of propellant material comprises a plurality of propellant grains that are each formed with a selected shape. An igniter can be coupled to the housing at a second longitudinal end thereof. The igniter can be adapted to initiate a combustion of the quantity of propellant material when the thruster device is deployed.

Additional embodiments of the present disclosure include methods for making a thruster device that is capable of being employed in a flight body. One or more implementations of such methods may include forming a housing that comprises a first longitudinal end and an opposing second longitudinal end, where the housing defines a combustion chamber and includes an injection nozzle at the first longitudinal end. A plurality of propellant grains can be disposed in the combustion chamber of the housing. Each propellant grain comprises a selected shape. An igniter may be coupled to the second longitudinal end of the housing. The igniter can be adapted to initiate a combustion of the plurality of propellant grains during deployment of the thruster device.

### BRIEF DESCRIPTION OF THE SEVERAL VIEWS OF THE DRAWINGS

Exemplary embodiments of the disclosure will become more fully apparent from the following description and appended claims, taken in conjunction with the accompanying drawings. Understanding that these drawings depict only exemplary embodiments and are, therefore, not to be considered limiting of the disclosure's scope, the exemplary embodiments of the disclosure will be described with additional specificity and detail through use of the accompanying drawings in which:

FIG. 1 is a side elevation view illustrating an example of a flight body embodied as a rocket or missile;

FIG. 2 shows a cross-sectional view of the flight body taken at section 2-2 in FIG. 1 and showing an example of a lateral thrust module according to at least one embodiment;

FIG. 3 illustrates a cross-sectional view of a thruster device according to at least one embodiment;

FIGS. 4-6 illustrate some examples of various discrete pellet-shaped grains that may be employed as some or all of the quantity of solid propellant material employed in a thruster device according to various embodiments of the present disclosure;

FIG. 4 illustrates an example of discrete propellant grains formed into individual pellet-shaped grains formed as tablets;

FIG. 5 illustrates an example of discrete pellet-shaped propellant grains formed into individual wafers;

FIG. 6 illustrates an example of discrete propellant grains formed into individual pellet-shaped grains formed as hollow cylinders; and

FIG. 7 is a flow diagram illustrating at least one embodiment of a method for forming a thruster device.

### DETAILED DESCRIPTION

The illustrations presented herein are, in some instances, not actual views of any particular thruster devices, lateral thrust modules or flight bodies, but are merely idealized representations which are employed to describe the present disclosure. Additionally, elements common between figures may retain the same numerical reference designation.

Various embodiments of the present disclosure include thruster devices and thrust modules for use in various flight bodies. FIG. 1 is a side elevation view showing an example of a flight body 100, embodied as a rocket or missile. Such a flight body 100 may typically include a generally cylindrical shape, with a projectile tip (or nose cone) 102 at a leading end, and a plurality of stabilizing fins 104 at a trailing end. Located generally between the leading and trailing ends, the flight body 100 may include a plurality of apertures 106 around a circumference thereof. Each of the plurality of apertures 106 is associated with a thruster of a lateral thrust module to facilitate control of the attitude and direction of the flight body 100. Although only a single row of apertures 106 in the longitudinal direction are shown, various embodiments of flight bodies may include two or more rows of apertures 106 in the longitudinal direction.

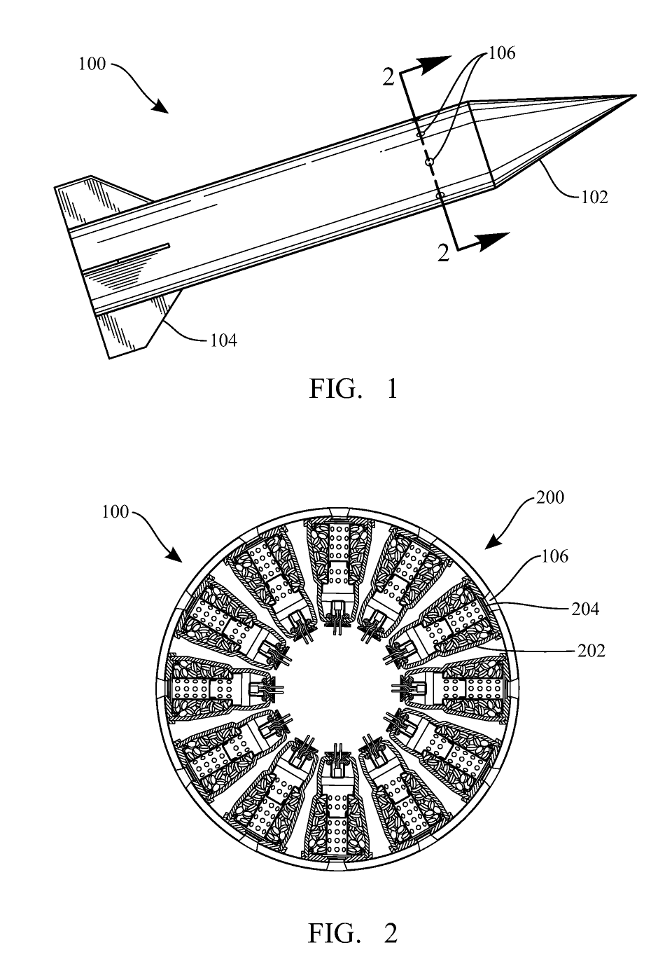

FIG. 2 shows a cross-sectional view of the flight body 100 taken at section 2-2 in FIG. 1 and showing an example of a lateral thrust module 200 according to at least one embodiment. As depicted, the flight body 100 includes a lateral thrust module 200 comprising a plurality of thrusters (or thruster devices) 202 arranged in a circumferential direction about the flight body 100 to generate a thrust directly toward the radial direction of the flight body 100. Each thruster 202 is oriented to direct its respective thrust in a unique direction from the other thrusters 202. Each thruster 202 includes an injection nozzle 204 joined to an aperture 106 of the flight body 100. The thrusters 202 are adapted to generate a thrust by combusting a propellant disposed therein, which combustion causes hot gases to exit through the injection nozzle 204 in a transverse direction relative to the flight body 100. Various features of the propellant will be described herein below.

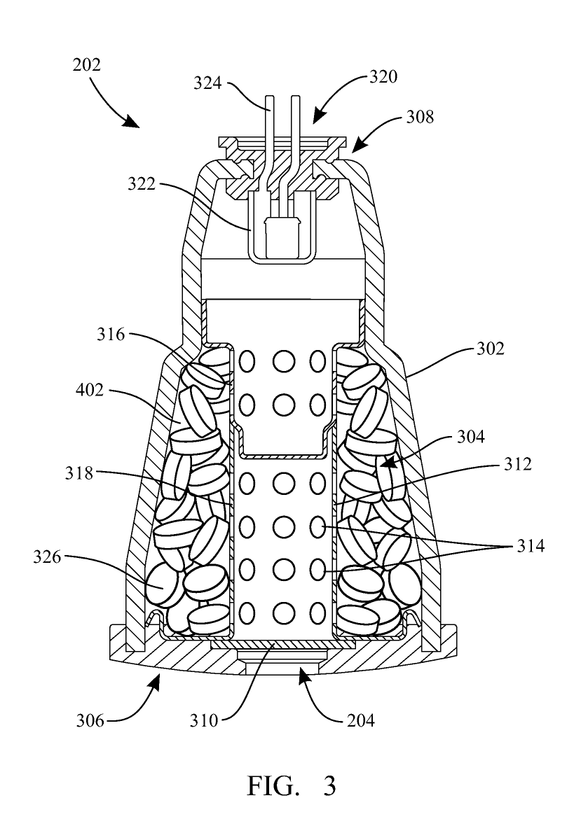

FIG. 3 illustrates a cross-sectional view of a thruster 202 according to at least one embodiment. The thruster 202 generally includes a housing 302 that defines a combustion chamber 304. The housing 302 may comprise a generally frusto-conical shape that includes a relatively larger diameter at a bottom (or first) longitudinal end 306 (as oriented in FIG. 2) and generally tapers to a relatively smaller diameter at the top (or second) longitudinal end 308. The injection nozzle 204, which can be joined to an aperture 106 of a flight body 100 (as shown in FIG. 2), may comprise an aperture that is disposed at the bottom longitudinal end 306. A burst disk 310 may be disposed to close off the injection nozzle 204 and substantially enclose the combustion chamber 304 prior to deployment. The burst disk 310 is adapted to fail (e.g., rupture) upon deployment of the thruster 202.

Within the combustion chamber 304, a conduit 312 may be disposed. As shown herein, the conduit 312 comprises a cylindrical tube having a plurality of holes 314 formed in the sidewall of the conduit 312. The illustrated conduit 312 includes two portions shown separated by a wall, an igniter portion 316 and a propellant portion 318.

An igniter 320 is coupled to the housing 302 at the top longitudinal end 308. The igniter 320 may generally include a squib 322 coupled to one or more wires 324 for creating an initial reaction upon receipt of a current and/or electrical charge via the one or more wires 324. In addition, the igniter 320 may include a quantity of combustible material (not shown) capable of being combusted upon deployment of the squib 322. Upon ignition of the squib 322 and/or the combustible material of the igniter 320, the hot gases generated may flow through the igniter portion 316 of the conduit 312 and out through the holes 314 to ignite a quantity of solid propellant material 326 disposed within the combustion chamber 304 and generally positioned around an outer surface of the conduit 312. Hot gases generated by combustion of the propellant material 326 enter into the propellant portion 318 of the conduit 312 through holes 314, increasing the internal pressure and causing the burst disk 310 to rupture. After the burst disk 310 ruptures, the thrust gases exit through the injection nozzle 204.

The propellant material 326 may comprise any conventional propellant material comprising a relatively normal or even slow burn rate. By way of example and not limitation, the propellant material may be selected to comprise a burn rate between about 0.5 in/sec. and 2 in/sec. (about 12.7 mm/sec. and 50.8 mm/sec.). In at least some implementations, the propellant material 326 may comprise a composite propellant material. In general, composite propellants typically comprise a metallic fuel, such as aluminum and/or magnesium, mixed with an oxidizer and immobilized with a rubbery binder such as synthetic rubber. Composite propellants may comprise an ammonium nitrate-based composite propellant (ANCP) or an ammonium perchlorate-based composite propellant (APCP). In at least some implementations, other propellant materials 326 may be employed such as, by way of example and not limitation, variations of boron potassium nitrate (BKNO3) or basic copper nitrate (BCN), and/or guanidine nitrate (GuNO3)-based gas generating materials, as well as any other propellant formulations including fuels and oxidizers.

The propellant material 326 is typically employed in forms called grains. A grain generally comprises an individual unit of propellant, no matter the size. Conventionally, the propellant grain is formed by casting the propellant material into a single grain that is sized and shaped to fill substantially all of the combustion chamber of a solid propellant motor. Cast grains, however, can vary significantly from part to part and cannot be easily or accurately adjusted prior to loading.

According to at least one feature of the present disclosure, the thruster 202 employs a quantity of solid propellant material 326 that comprises a plurality of discrete grains, which are formed into one or more selected shapes. In at least some implementations, the discrete grains may be formed by subjecting the propellant material 326 to high pressure to press the propellant material into the selected shape for each grain. A binder, such as an organic or non-organic binder, can be employed when pressing the propellant material into the selected shape. By way of example only, the binder may comprise a rubber binder such as Hydroxyl-terminated polybutadiene, or the binder may comprise a guanidine nitrate or similar material given the forces encountered during pressing operations. In at least some other implementations, the discrete grains may be formed by extruding the propellant material 326 to form the discrete grains with the desired shape.

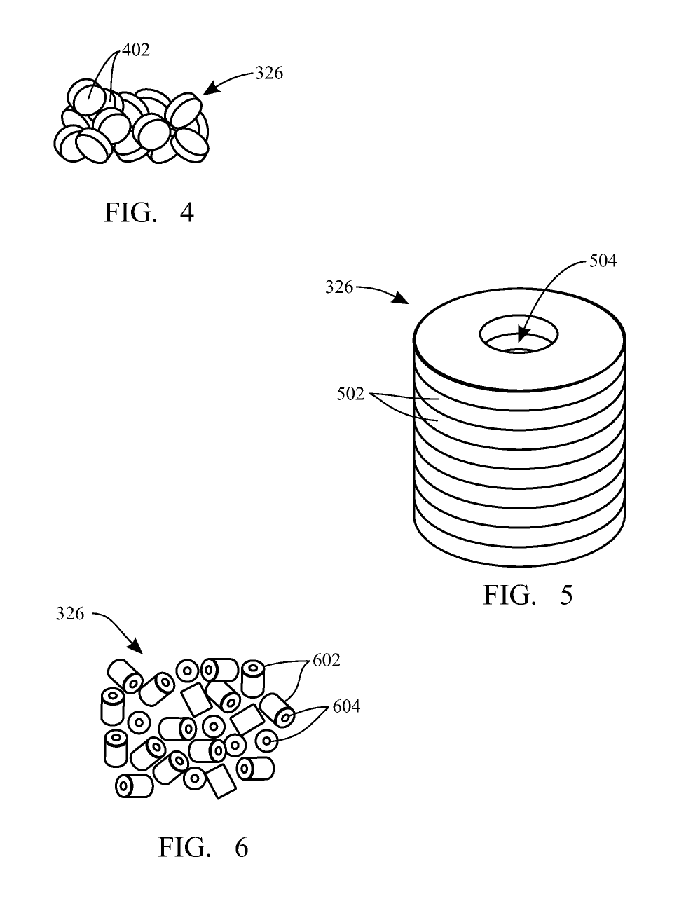

The discrete grains comprising the quantity of solid propellant material 326 can be shaped and sized according to a plurality of different embodiments. For example, the various discrete grains employed as some or all of the quantity of solid propellant material 326 may comprise one or more configurations of pellet-shaped grains. Such pellet-shaped grains 402 can have any of a plurality of general shapes. By way of example and not limitation, the pellet-shaped grains can be generally spherical, elliptical, ovoid, cylindrical, toroidal and/or tablet-shaped. FIGS. 4-6 illustrate some examples of various discrete pellet-shaped grains that may be employed as some or all of the quantity of solid propellant material 326 employed in a thruster 202. Turning first to FIG. 4, an example of a quantity of solid propellant material 326 is shown, where the pellet-shaped propellant grains are formed into individual tablet-shaped grains 402. Each tablet-shaped grain 402 has a generally cylindrical shape. According to at least some embodiments, such tablet-shaped grains 402 may generally have a height that is relatively smaller than the cross-sectional diameter of the cylinder. The tablet-shaped grains 402 can be randomly packed into the combustion chamber 304 as illustrated in FIG. 3, which shows an embodiment of the thruster 202 employing an example of pellet-shaped grains configured as tablets 402 in the combustion chamber 304.

FIG. 5 illustrates an example of a quantity of solid propellant material 326 where the pellet-shaped propellant grains are formed into individual wafers 502. Each wafer 502 also has a generally cylindrical or toroidal shape with a hole 504 longitudinally extending therethrough. The wafers 502 are relatively larger than the pellet-shaped grains formed as tablets 402. For example, each wafer 502 may be sized and shaped so that when the wafer 502 is positioned in a combustion chamber 304 of a thruster 202 (see FIG. 3), the conduit 312 (see FIG. 3) can be positioned to extend through the hole 504 of each wafer 502. In other words, each wafer 502 may encircle a portion of the conduit 312 with the hole 504, and may extend radially outward from the conduit 312 to substantially fill a portion of the combustion chamber 304. A plurality of such wafers 502 can be stacked on top of each other (as shown in FIG. 5) to at least substantially fill the combustion chamber 304. Although the wafers 502 shown in FIG. 5 have substantially the same diameter, each of the wafers 502 could comprise differing diameters to fill a combustion chamber that varies in size, such as the combustion chamber 304 in FIG. 3.

Various embodiments of the wafers 502 may comprise one or more surface irregularities, such as grooves, indentations, slots, channels, and the like of different shapes formed in one or more surfaces of the wafer 502 so that the generally flat sides of each wafer 502 do not abut or seat in abuting relationship against any adjacent wafer 502. For example, one or more irregularities may be formed in a top and/or bottom surface (as oriented in FIG. 5), which extend from the hole 504 to an outer side surface. Such irregularities provide combustible surfaces along the generally flat sides (e.g., top and/or bottom surface) of each wafer 502. Additionally, in at least some embodiments, the hole 504 may comprise other shapes than the circular hole 504 shown in FIG. 5.

FIG. 6 shows an example of a quantity of solid propellant material 326 where pellet-shaped propellant grains are generally formed into individual hollow cylinders 602. Each pellet-shaped grain formed as a hollow cylinder 602 has a generally cylindrical or toroidal shape with a longitudinally extending hole 604 through a central portion thereof. Such hollow cylinders 602 can be substantially smaller in size than the wafers 502 in FIG. 5 and can be randomly packed into the combustion chamber 304, in a manner similar to the pellet-shaped grains formed as tablets 402 depicted in FIG. 3. The hollow cylinders 602 can be similar in size to the tablet-shaped grains 402, but may differ from the tablet-shaped grains 402 by being hollow (i.e., have a hole 604 extending therethrough).

By using a plurality of discrete grains, such as any of the examples of pellet-shaped grains just described, the ignitable surface area for the quantity of solid propellant material 326 within the combustion chamber 304 is substantially increased, while maintaining a relatively smaller burning thickness or web. As a result, a thruster design can be achieved which exhibits reasonable combustion pressure (e.g, between about 2,000 psi (about 13.79 MPa) and about 10,000 psi (about 68.95 MPa)) while using a relatively lower burning rate propellant material 326 that is still capable of exhibiting a relatively short action time. Such slower burning propellant materials are generally more stable and more predictable than the conventional high burning-rate materials used in conventional thrusters exhibiting short action times. In addition, propellant materials exhibiting relatively lower burning rates are typically easier and cheaper to manufacture, without substantial variations between manufacturing lots. Employing a slower burning propellant material can result in more repeatable (i.e., less variable) thrust forces produced by thrusters 202 of the present disclosure.

The various embodiments of discrete grains of solid propellant material 326 provided above are merely some examples of suitable sizes and/or shapes for discrete grains employed in one or more thrusters 202 of the present disclosure. Other sizes and/or shapes of discrete grains may also be employed in one or more thrusters 202 according to other various embodiments of the present disclosure. Furthermore, various implementations of the current thrusters 202 may employ a combination of more than one size and/or shape of discrete grains for the solid propellant material 326. That is, in some embodiments, a thruster 202 may employ a combination of two or more different embodiments of discrete grains of solid propellant material 326, for example pellet-shaped grains formed as both tablets and hollow cylinders.

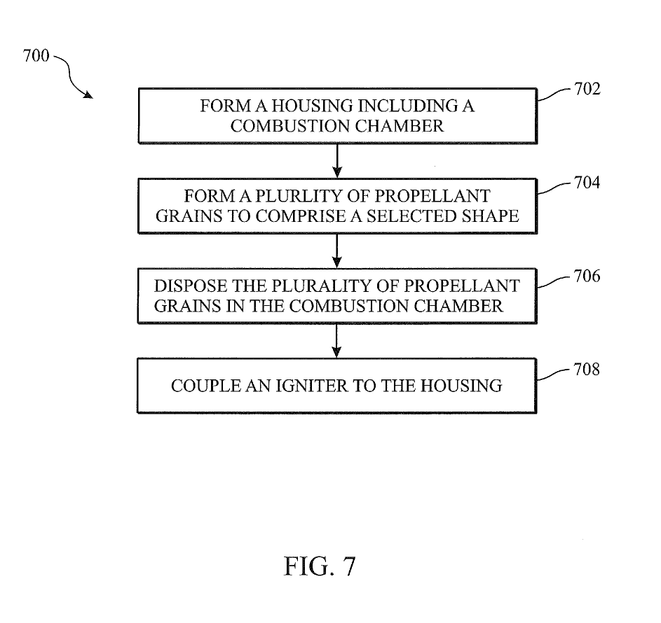

Additional embodiments of the present disclosure relate to methods of forming thrusters, such as thrusters 202. FIG. 7 is a flow diagram illustrating at least one implementation of a method 700 for making a thruster device, such as thruster 202 in FIGS. 2 and 3, according to at least one embodiment of the current disclosure. With reference to FIG. 7 as well as FIG. 3, a housing 302 may be formed at step 702. The housing 302 is formed with a first longitudinal end 306 and an opposing second longitudinal end 308. The housing 302 is formed to define a combustion chamber 304. In addition, the housing 302 can include an injection nozzle 204 at the first longitudinal end 306.

At step 704, a plurality of propellant grains are formed to comprise at least one selected shape. For example, the plurality of propellant grains can comprise pellet-shaped grains (see, e.g., FIGS. 4-6), as well as some combination of two or more differently shaped grains. In at least some implementations, the plurality of propellant grains can be formed into their respective shapes by subjecting the propellant material to high pressures in a mold to press the propellant material into the selected shape. A binder, such as an organic or non-organic binder, can be employed when pressing the propellant material into the selected shape. In at least some other implementations, the plurality of propellant grains can be formed into their respective shapes by extruding the propellant material using an extruder, to form individual propellant grains having the selected shape.

At step 706, the plurality of propellant grains are disposed in the combustion chamber 304 of the housing 302. For example, the plurality of propellant grains can be randomly packed into the combustion chamber 304 in some implementations (e.g., tablet-shaped grains, hollow cylinder grains), while the propellant grains also can be selectively positioned in the combustion chamber 304 in other implementations (e.g., wafer-shaped grains).

At step 708, an igniter 320 can be coupled to the second longitudinal end 308 of the housing 302. The igniter 320 can be adapted to initiate a combustion of the plurality or propellant grains during deployment of the thruster device.

The various embodiments and implementations of the present disclosure result in thruster devices and lateral thrust modules with relatively low performance variability. In particular, the use of the discrete propellant grains, as described herein, provides for a more consistent thrust value over conventional devices, at least in part as a result of the ability to more accurately load the propellant grains by weight from thruster device to thruster device.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A thruster device employable in combination with one or more other thruster devices in a flight body for generating a transverse thrust, the thruster device comprising:
a combustion chamber;
a plurality of propellant grains disposed within the combustion chamber, wherein at least some of the plurality of propellant grains are formed into at least one selected shape; and
an igniter located in relation to the plurality of propellant grains to initiate a combustion of the plurality of propellant grains when the thruster device is deployed.

2. The thruster device of claim 1, wherein at least some of the plurality of propellant grains are formed as discrete pellet-shaped grains.

3. The thruster device of claim 2, wherein at least some of the plurality of discrete pellet-shaped propellant grains are formed with at least one of a spherical shape, elliptical shape, ovoid shape, cylindrical shape, toroidal shape or tablet shape.

4. The thruster device of claim 1, wherein the combustion chamber is defined by a generally frusto-conical housing.

5. The thruster device of claim 1, wherein the plurality of propellant grains comprise two or more different selected shapes.

6. The thruster device of claim 1, wherein at least some of the plurality of propellant grains are formed by pressing propellant material into the at least one selected shape.

7. The thruster device of claim 1, wherein at least some of the plurality of propellant grains are formed by extruding a propellant material into the at least one selected shape.

8. A lateral thrust module employable in a flight body for adjusting attitude and direction of the flight body, the lateral thrust module comprising:
a plurality of thruster devices, each oriented to direct a thrust in one of a plurality of different directions, where each thruster device includes:
a housing defining a combustion chamber and including an injection nozzle at a first longitudinal end thereof, wherein the injection nozzle is adapted to be joined to an aperture of a flight body;
a quantity of propellant material disposed within the combustion chamber, the quantity of propellant material comprising a plurality of propellant grains, each formed with at least one selected shape; and
an igniter coupled to the housing at a second longitudinal end thereof, the igniter adapted to initiate a combustion of the quantity of propellant material when the thruster device is deployed.

9. The lateral thrust module of claim 8, wherein the plurality of propellant grains are formed into at least one discrete pellet-shaped grain.

10. The lateral thrust module of claim 9, wherein at least some of the plurality of discrete pellet-shaped propellant grains are formed with at least one of a spherical shape, elliptical shape, ovoid shape, cylindrical shape, toroidal shape or tablet shape

11. The lateral thrust module of claim 8, wherein each thruster device further comprises a conduit including a plurality of holes formed in a sidewall thereof, the conduit disposed within the housing so that the quantity of propellant material is located around an outside surface of the conduit.

12. The lateral thrust module of claim 8, wherein the quantity of propellant material comprises one of a composite propellant, a boron potassium nitrate (BKNO3) propellant, a basic copper nitrate (BCN) propellant, a guanidine nitrate (GuNO3)-based propellant, or other formulation comprising one or more fuels and one or more oxidizers.

13. The lateral thrust module of claim 8, wherein the propellant grains of the quantity of propellant material comprise two or more different selected shapes.

14. A method of making a thruster device employable in a flight body, the method comprising:
forming a housing comprising a first longitudinal end and an opposing second longitudinal end, wherein the housing defines a combustion chamber and includes an injection nozzle at the first longitudinal end;
disposing a plurality of propellant grains in the combustion chamber of the housing, wherein each propellant grain comprises a selected shape;
coupling an igniter to the second longitudinal end of the housing, the igniter being adapted to initiate a combustion of the plurality of propellant grains during deployment of the thruster device.

15. The method of claim 14, wherein the step of disposing the plurality of propellant grains in the combustion chamber of the housing, wherein each propellant grain comprises a selected shape comprises:
disposing the plurality of propellant grains in the combustion chamber of the housing, wherein at least some of the propellant grains comprise a discrete pellet shape.

16. The method of claim 15, wherein the step of disposing the plurality of propellant grains in the combustion chamber of the housing, wherein at least some of the propellant grains comprise a discrete pellet shape comprises:
disposing the plurality of propellant grains in the combustion chamber of the housing, wherein at least some of the propellant grains comprise at least one of a spherical shape, elliptical shape, ovoid shape, cylindrical shape, toroidal shape or tablet shape.

17. The method of claim 14, wherein forming the housing comprises forming the housing with a generally frusto-conical shape.

18. The method of claim 14, wherein the step of disposing the plurality of propellant grains in the combustion chamber of the housing, wherein each propellant grain comprises a selected shape comprises:
disposing the plurality of propellant grains comprising two or more different selected shapes in the combustion chamber of the housing.

19. The method of claim 14, further comprising:
forming the plurality of propellant grains with the selected shape by pressing a propellant material into the selected shape.

20. The method of claim 14, further comprising:
forming the plurality of propellant grains with the selected shape by extruding a propellant material into the selected shape.

21. The method of claim 14, further comprising:
positioning a conduit in the housing so that the quantity of propellant material is located around an outside surface thereof, the conduit including a plurality of holes disposed in a sidewall thereof.
